(19) United States
(12) Patent Application Publication
(10) Pub. No.: US 2015/0178372 A1
(43) Pub. Date: Jun. 25, 2015

(54) CREATING AN ONTOLOGY ACROSS MULTIPLE SEMANTICALLY-RELATED DATA SETS

(71) Applicant: OpenGov, Inc., Mountain View, CA (US)

(72) Inventor: Matthew SEAL, Sunnyvale, CA (US)

(73) Assignee: OpenGov, Inc., Mountain View, CA (US)

(21) Appl. No.: 14/134,741

(22) Filed: Dec. 19, 2013

(51) Int. Cl. G06F 17/30

(52) U.S. Cl. CPC G06F 17/30598; G06F 17/30899

(57) ABSTRACT

Embodiments presented herein disclose techniques for generating an entity pool, a hierarchical structure of related nodes that assists with classification and comparison of dissimilar data sets. To generate the entity pool, text references and metadata are collected from a public source, such as an online encyclopedia or other text source that provides dense and structured data that focuses on identified terminology. The text references are assigned similarity scores based on contextual information provided by the metadata. The text references are clustered into nodes based on similarity. Relationships between the nodes are defined based on edges generated between the nodes.

### BACKGROUND

1. Field

Embodiments presented herein generally relate to techniques of natural language processing, classification, and text mining. More specifically, techniques are disclosed for generating ontologies from semantically-related yet structurally dissimilar data sets.

2. Description of the Related Art

Open data, the concept of making certain data freely available to the public, is of growing importance. For example, demand for government transparency is increasing, and in response, governmental entities are releasing a variety of data to the public. One example relates to financial transparency for governmental entities (e.g., a city or other municipality) making budgets and other finances available through data accessible to the public. Doing so allows for more effective public oversight. For example, a user may analyze the budget of a city to determine how much the city is spending for particular departments and programs. Additionally, users may compare budgetary data between different cities to determine, for example, how much other cities are spending on respective departments. This latter example is particularly useful for a department head at one city who wants to compare spending, revenue, or budgets with comparable departments in other cities.

An issue that arises in providing public access to this kind of financial data is presenting the data in a useful manner. For instance, in the previous example, budgetary data for a given city government is often voluminous. Consequently, users accessing the data may have difficulty discerning relevant information. To address such an issue, computer applications may parse and process the budgetary data in a manner that is presentable to a user (e.g., by generating graphs, charts, and other data analytics).

However, comparing such data with the budgetary data of other cities introduces additional complexities. One such complexity is resolving differently-labeled departmental entities. More specifically, departments providing the same function in two cities may use different names, making comparisons difficult. As an example, a city department that handles water sewage could be called “Sewage Processing” in one city and “Water Treatment” in another city. Another complexity is differences between organizational structures between cities. In such cases, hierarchical differences between the departments of different cities may create further issues. For example, although “Sewage Processing” may be its own department in one city, “Water Treatment” may be a sub-department of a “Public Works” department in another city. Software applications rely on natural language processing (NLP) techniques to resolve the labels into similar entities, but many current approaches require a substantial amount of preprogramming (i.e., hard-coding associations and relationships to the entities themselves). Such approaches are not scalable and are often error prone.

### SUMMARY

Embodiments presented herein include a method for generating an entity pool that maps elements from multiple hierarchies to a normalized hierarchy of nodes. This method may generally include identifying a first plurality of mentions and metadata. Each mention provides a text string. The metadata specifies hierarchical information about the corresponding mention. This method may also include grouping mentions based on a first measure of similarity. A node in an entity pool that stores each group of mentions is generated. This method may also include identifying relationships between pairs of nodes in the entity pool. Each relationship between a given pair of nodes is assigned a second measure of similarity, determined based on the mentions stored by each node of a given pair.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates an example computing environment, according to one embodiment.

FIGS. 2A and 2B illustrate an example interface of a financial transparency application, according to one embodiment.

FIG. 3 illustrates an example of an entity pool, according to one embodiment.

FIG. 4 illustrates an example of mentions in two departmental hierarchies mapped to a common entity in an entity pool, according to one embodiment.

FIG. 5 illustrates a method for generating an entity pool, according to one embodiment.

FIG. 6 illustrates an example server computing system configured with an application configured to generate an entity pool, according to one embodiment.

### DETAILED DESCRIPTION

Embodiments presented herein provide techniques for generating an ontological structure for semantically-related yet hierarchically dissimilar data sets. In one embodiment, the ontological structure may be generated by parsing public resources (e.g., online encyclopedias) for common hierarchical structures and naming conventions. After collecting this data, semantic relationships between different nouns and noun phrases are defined. Nouns (and noun phrases) with similar meanings are clustered into a node. Once clustered, hierarchical relationships between nodes are defined, creating the ontological structure. The ontological structure provides a relatively complete vocabulary and normalized hierarchical structure that allows a user to classify and analyze multiple semantically-related, yet structurally dissimilar data sets.

Consider budget data for two cities. Both cities may account for departments, funds, services, and revenues differently, while still providing comparable services and functions. Departments in both cities that serve similar functions might not share the same name. For example, a “Sewage Processing” department in City A may be referred to as a “Water Treatment” department in City B. Further, the departments in each city may be located in a different tier in the corresponding chart of accounts. For example, “Water Treatment” may be a sub-department of a “Public Works” department in one city, while “Sewage Processing” is its own department in the other city. This creates difficulty for an individual in one city (e.g., a citizen, city planner, administrator, etc.) to compare the budget data of the other city.

To address this issue, techniques presented herein disclose an approach for generating an entity pool that may be used to compare data between multiple differently-structured hierarchies. In one embodiment, the entity pool is a normalized hierarchy of nodes (“entities”). Generally, an entity represents real world concepts or objects. For example, an entity may refer to a concept of a department that handles sewage treatment. Each entity is associated with one or more elements, known as “mentions.” Mentions are contextualized references (often represented as nouns or noun phrases) to an entity. For example, “Sewage Processing” and “Water Treatment” are mentions that may refer to the concept of the department that handles sewage treatment. Further, the entity pool defines relationships between each entity, such as whether a given entity is a “parent” or a “child” of another entity. The entity pool maps semantically-related mentions of different hierarchies to entities in the pool, such that a mention of another hierarchy may be easily identified based on a selected mention. Doing so allows users to compare similar items across multiple data sets, even if the data sets are not structured similarly or if the items are labeled differently.

In one embodiment, techniques described herein are used by a financial transparency application which allows users to view and analyze budgetary data of state and local governments. Using the financial transparency application, the user may view the amount of money spent on various city departments. The financial transparency application may provide the user with graphs and other analytical structures for further analysis. The financial transparency application uses the entity pool to resolve elements (e.g., department names, budget line items, accounts, etc.) between different city hierarchies and present data associated with each element to the user. Of course, the techniques described herein may also be used in a variety of contexts beyond governmental entities, such as with non-profit organizations, homeowner associations, and universities.

In one embodiment, the entity pool is generated by parsing public sources (e.g., online encyclopedias, charts of accounts, and other documents where common names and hierarchies can be ascertained) to retrieve mentions and contextual information about each mention. The mentions and contextual information about the mentions (e.g., a frequency a given mention appears in the source, a location in the source where the mention is found, etc.) are used to identify common hierarchical structures and naming conventions for each city, such as structures for departments, budgets, ledgers, and revenues and expenses. Mentions having similar meanings are clustered into entities. For example, a “Law Enforcement” department of a City A and a “Police” department of a City B may be clustered to the same entity. Further, relationships between entities (such as parent-child relationships) are defined for each entity. For example, an entity mapping from a “Parking Services” sub-department may be defined as a child of the entity associated with law enforcement.

As described below, unclustered mentions may be associated with an entity in the entity pool using natural language processing techniques. Because the entity pool is generated using such techniques, the entity pool provides a normalized vocabulary and classification structure that may be used for a variety of purposes. For example, the entity pool may be used to resolve disparities between differing hierarchies. Advantageously, users may make meaningful comparisons of dissimilar data sets of separate hierarchies.

Further, the unsupervised learning techniques described herein may be used to generate the entity pool (e.g., as opposed to supervised training techniques that rely on a significant amount of manually provided input). Advantageously, doing so allows learning on large data sets that have not been manually classified. This is particularly useful in a variety of real world contexts where data is not well-mapped to common ontologies (such as the case with governmental hierarchies). Additionally, using unsupervised learning techniques may reduce the risk of overfitting data for the entity pool, which in turn results in a structure that may reliably be scaled to evaluate multiple hierarchies.

Note, the following description relies on a financial transparency software application as a reference example for generating an entity pool and using the entity pool to resolve differences in multiple governmental organizational structures. However, one of skill in the art will recognize that embodiments are applicable in other contexts related to classifying elements of separate structural hierarchies into comparable entities. For example, embodiments may be used to generate an entity pool used to compare and analyze disclosed earnings data between competing business organizations. An application may retrieve annual reports from websites of business organizations and parse the reports for semantic data to generate the pool. As another example, embodiments may be used to generate an entity pool used to compare other, non-financial metrics between local governments, such as crime statistics, where each city uses a different set of descriptions for classifying crime or characterizing statistics.

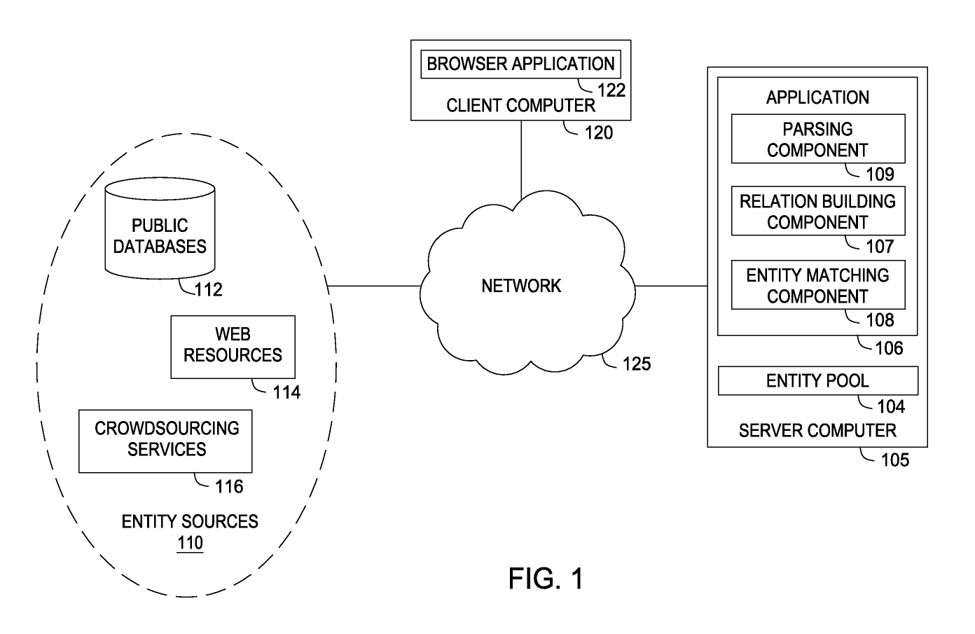

FIG. 1 illustrates an example computing environment 100, according to one embodiment. As shown, the computing environment 100 includes a server computer 105. The server computer 105 may be a physical computing system (e.g., a system in a data center) or a virtual computing instance executing within a computing cloud. In one embodiment, the server computer 105 hosts a financial transparency application 106. The application 106 allows a user (e.g., an administrator, city planner, citizen, etc.) to browse budget data of different state and local governments.

For example, users of application 106 may retrieve budget data for multiple cities and compare expenditures between specific departments of each city. For instance, assume the user wants to compare City A's expenditures on its “Auditor-Controller” department relative to how much City B is spending for comparable functions and services. In such a case, the user, e.g., through an interface on a client computer 120, may select “City A” and “Auditor-Controller,” and then also select “City B.” The application 106 receives the data selections and iterates through an entity pool 104 to identify an entity corresponding to the selection of “Auditor-Controller” in City A. After identifying the entity associated with “Auditor-Controller” for City A, the application 106 iterates through the City B hierarchy to identify a corresponding entity. Doing so allows the application 106 to identify a budget item in City B that corresponds to the “Auditor-Controller” item in the City A budget (even though City B may label the budget item with a different name, such as “Accounting”). Once resolved, the application 106 retrieves budget item data corresponding to both departments and returns the data to the client computer 120.

In one embodiment, entity pool 104 provides a group of objects, also referred to as “entities” and relationships between such entities. The entities themselves are groups of strings, referred to as “mentions.” Each mention is associated with an entity in the entity pool 104. A “mention” may also include contextual information relevant to associating the mention to an entity. In the previous example, “Auditor-Controller” and “Accounting” are mentions that refer to a departmental entity serving a similar accounting function.

The application 106 generates the entity pool 104 based on various entity sources 110. Such entity sources 110 may include documents from public databases 112, such as charts of accounts from different cities. Other entity sources 110 may include web resources 114, such as online encyclopedias. Another example of an entity source 110 is a crowdsourcing service 116, such as the Amazon Mechanical Turk.

A parsing component 109 may iterate through web services 114 (or other documents from public databases 112) to scrape mentions and relevant contextual information (e.g., the frequency upon which the mention appears, the location of the mention in the resource, other words adjacent to the mention, and so on). After parsing web resources 114, a relation building component 107 determines relationships between mentions based on the contextual information collected from the web resources 114. The relation building component 107 then clusters related mentions, which results in a relationship graph populated with mentions connected to each other by weighted edges. The relation building component 107 further associates the mentions with entities based on similarity scores determined from the weighted edges. Doing so results in the entity pool 104. Given contextual information corresponding to mentions associated with certain entities, the relation building component 107 may identify relationships (e.g., parent-child relationships) between the entities.

The financial transparency application 106 uses an entity matching component 108 to identify corresponding entities in a relationship set within the entity pool 104.

Note, even if a given mention is absent in a generated entity pool, the relation building component 107 may still map the mention to an entity if semantically-related mentions are already present in the entity pool. In such a case, an ontology may act as a thesaurus for some mentions. For example, assume a mention of “Law Enforcement” is not in the entity pool, and that “Police” is present in the entity pool. In such a case, the financial transparency application 106 may use natural language processing techniques to match to “Police” and “Law Enforcement.”

Additionally, the relation building component 107 may be configured to receive feedback from crowdsourcing services 116. Generally, a crowdsourcing service 116 uses input from a large network of human contributors to solve a particular problem. An organization (a “crowdsourcer”) broadcasts a problem to a group of unknown users (a “crowd”). In response, the crowd submits solutions to the crowdsourcer. One example of a crowdsourcing service 116 includes the Amazon Mechanical Turk. After the parsing component 109 retrieves mentions from entity sources 110, the mentions may be sent to a crowdsourcing service 116. The crowdsourcing service 116 may be used to group mentions into entities and identify other mentions that belong to the entities. The crowdsourcing service 116 may be used to identify hierarchical relationships between the entities. Additionally, the crowdsourcing service 116 may be used to refine existing relationships. For example, the crowdsourcing service may determine whether a certain mention is accurately mapped to a given entity (and potentially identify a more suitable mapping if not).

FIG. 1 illustrates merely one possible configuration of the embodiments and should not be construed as limiting. For example, the parsing component 109, relation building component 107, and entity matching component 108 may be executed as separate applications on one or more server computers. Further, the components may be executed as applications separate from the financial transparency application 106. The financial transparency application 106 may access the entity pool 104 without any information of how the entity pool 104 was generated.

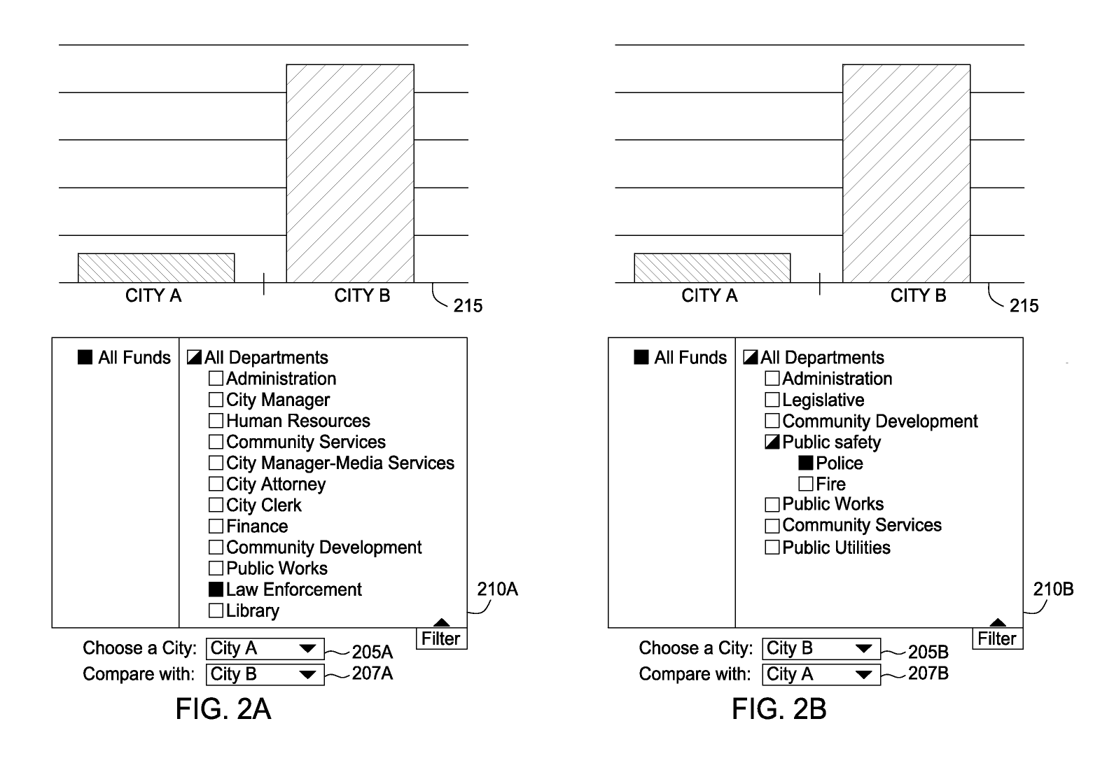

FIGS. 2A and 2B illustrate an example interface of a financial transparency application, according to one embodiment. As described, the financial transparency application allows users to evaluate comparable financial and budgetary data related to different cities. A user may select a city by clicking on a dropdown box 205. Once selected, the application may display financial information, grouped by department on a graph 215 on the interface. The financial information presented may correspond to the accounting and budget structure of the city (e.g., funds, departments, projects, and revenues and expenses, etc.). Further, the user may compare the budgets of other cities with the currently selected one (City A). To do so, the user selects another city by clicking on the dropdown box 207. As a default, the financial transparency application may present budget data corresponding to all departmental funds. To refine the selection, the user may filter departments displayed on graph 215 through a filter menu 210. The department names on the filter menu correspond to the names given by the city selected in the dropdown box 205. Note that the interface may also provide the capability of comparing more than two cities.

In FIG. 2A, a user is comparing a budget for the police department entity of City A (selected from the dropdown box 205A) to a budget the police department entity of City B (selected from dropdown box 207A). Note, importantly, because the two cities may have different accounting and ledger structures, simply identifying the same line items in two budgets is not possible. Instead, in one embodiment, the financial transparency application maps the selected line items from City A to an entity pool. Once mapped, the financial transparency application identifies the best matching line item when comparing budgetary data across different cities. As shown in the filter menu 210A, the user has selected to filter results to “Law Enforcement.” By filtering the results to “Law Enforcement,” the graph 215 displays information relating to only the police departments in City A and City B. FIG. 2B depicts the interface where the user compares the police department entity of City B (selected from the dropdown box 205B) to the police department entity of City A (selected from dropdown box 207B). As shown in the filter menu 210B, the user has selected to filter results to “Police.”

Note that the police department entities are labeled differently in City A (“Law Enforcement”) and City B (“Police”). It is common for departments serving relatively identical functions to have different names across different cities. To be able to compare the two departments, the financial transparency application resolves the word selections into a common entity located in a generated entity pool that establishes mappings between word mentions and entities. Using the entity pool allows the financial transparency application to identify the corresponding department in the city whose department is being compared. After identifying the corresponding department, the financial transparency application is able to retrieve the relevant budgetary data associated with each department and present the data to the user (e.g., through graph 215).

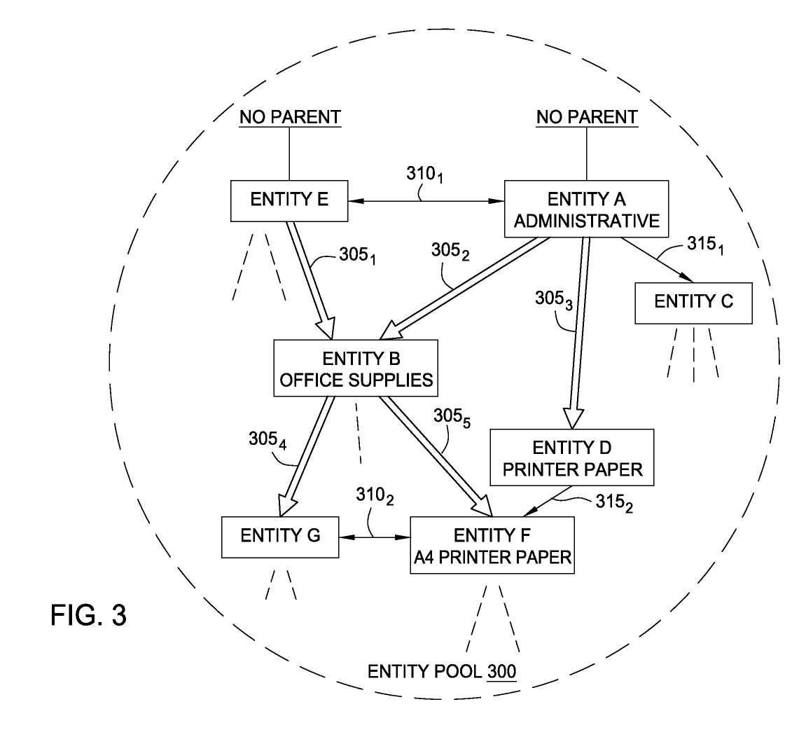

FIG. 3 illustrates an example of an entity pool 300, according to one embodiment. The entity pool 300 maps elements of a hierarchy to nodes (entities) in the pool. More specifically, the entity pool 300 defines hierarchical relationships between entities in the pool. For example, an entity may be a child of another entity or subset of another entity. As noted, each entity itself may correspond to a collection of “mentions” and other metadata used to define a given entity. Further, the entity pool 300 defines semantic relationships between the entities. Specifically, relationships between nodes may be weighted by a similarity to one another, based on contextual information obtained from public sources. For example, although an entity associated with a “Police Department” may be an entirely separate entity associated with a “Fire Department,” the relationship between the entities may nevertheless be highly weighted because both entities semantically relate to an overall “Public Safety” department.

To generate the entity pool, in one embodiment, a parsing component may scrape data from public sources, such as an online encyclopedia or other authoritative or semi-authoritative source. For example, the parsing component may evaluate an article describing a chart of accounts available in an online encyclopedia. As known, a chart of accounts is a list of accounts identifying classes of items for which money is spent or received for a given city department. A governmental entity may use the chart of accounts to organize finances by separating expenditures, revenues, assets, and liabilities of the entity. As such, the chart of accounts is a densely structured document that provides identifiable terminology and defines hierarchies within a given city.

In one embodiment, the financial transparency application parses each page to retrieve mentions and contextual information related to each mention. For example, such metadata may include a frequency of the mention appearing in the page, locations where the mention appears in the page, and descriptions of the mention. Additionally, the financial transparency application navigates through pages linked within the specified pages and collects information from the linked pages. After parsing the data, the relation building component determines relationships between mentions based on the collected phrases and contextual information.

The mentions are clustered to form a relationship graph. The relationship graph uses edges to connect nodes representing the mentions to other nodes. The edges may be weighted based on results of the clustering. Alternatively, the edges may represent arbitrary relationships that are evaluated with other relationships to generate edge weights. Doing so allows weights to represent different relationship aspects between the nodes (e.g., to represent overlapping relationships, differences in specificity between nodes, etc.).

The relation building component determines, based on the weighted edges, similarity scores. For instance, the relation building component may generate similarity scores by evaluating any contextual or phrase information between two mentions and determining a measure of similarity. The relation building component performs clustering techniques on the mentions based on the similarity scores to create an entity pool. Each entity in the pool provides a data structure storing, collectively, the mentions and attributes of that entity. As more mentions are associated with an entity, the financial transparency tool may determine a common name for the entity from the aggregate of mentions for that entity. Further, the relation building component may identify relationships between entities. The relation building component may define relationships between departments, ledger items, fund names, etc. For example, the relation building component may determine that an entity corresponding to a “Public Works” department is frequently related to an entity corresponding to a “Sewage Treatment” department based on observed relationships between mentions collected from data sources. The relation building component may determine weights between the entities. The more data used to populate the entity pool, the more refined the entities and relationships in the entity pool become.

The financial transparency application may scrape data from other public sources to generate the entity pool 300. For instance, another public source that the financial transparency application may use is a city's chart of accounts. As noted above, a chart of accounts provides mentions corresponding to each department and other contextual information related to each mention. Further, the parsing component may scrape additional public sources in combination with other public sources. For example, data from a third-party source (e.g., an online encyclopedia) may be used to establish a “ground truth” for the entity pool 300, and the charts of accounts for different cities may later be parsed to refine each entity in the existing entity pool 300. For instance, as more contextual information is added to the entity pool from the charts of accounts (or any other source), the relation building component may further ascertain similarities or differences between existing entities. Additionally, the relation building component may split entities after identifying additional nuances between mentions associated with the entity based on further collected contextual information.

After retrieving mentions and contextual information from the sources and associating the mentions with entities, the relation building component defines the relations between entities in the entity pool 300. The relation building component may define a relation between two nodes (i.e., between two entities) based on hierarchical information and contextual information collected when retrieving each mention. As shown in FIG. 3, relationships between entities are illustrated using edges connecting nodes in the pool. The two-way arrow 305 between entities depicts overlapping entities. For example, entities E and A are depicted as overlapping entities. Entities E and A may overlap due to similarities between each other but, due to nuances between the two, are not consolidated into the same entity. The double-lined arrow 310 depicts that the entity being pointed to is a “child of” a parent entity. For example, Entity B is a child-of parent entities E and A. A one-way arrow 315 depicts that an entity being pointed to is a subset of another entity. Of course, FIG. 3 depicts only a few relationships between each entity, but in practice, each entity may relate to more entities than described herein (as depicted by the dotted lines). For example, an entity can be a child of multiple entities. As another example, an entity can be a child of a certain entity as a sub-part of that entity. Generally, relationships between entities in the entity pool 300 may be inclusive (e.g., like relationships found between sets of a Venn diagram) while also allowing arbitrary relationships to be defined.

In the example of FIG. 3, entity pool 300 corresponds to line items in a city's budget. As shown, an Entity A is labeled “Administrative,” Entity B is labeled “Office Supplies,” Entity D is labeled “Printer Paper,” and Entity F is labeled “A4 Printer Paper.” Illustratively, Entities B and D are children of Entity A. Additionally, Entity F is a child of Entity B but also a subset of Entity D. The relation building component may ascertain various relationships between each entity as more data is collected.

In one embodiment, edges identifying relationships between entities may be assigned weighted measures based on the relational similarity between the entities. Such similarities may be determined using the contextual information of the mentions associated with each entity. For instance, a location of a certain mention relative to a location of another mention within a source may indicate similarity. Further, similarities may be determined using known natural language processing techniques. For instance, the relation building component may use such techniques on mentions to identify other mentions having similar semantic meaning. The financial transparency application may use the assigned weighted measures of the entities to identify a mapping of a mention in one hierarchy to a mention in another hierarchy in the event that both mentions do not match to an identical entity. For example, if a particular mention associated with a certain Entity X in a first hierarchy, and the second hierarchy has no corresponding mention associated with Entity X in the entity pool, the financial transparency application may identify another Entity Y that has a higher weight measure between Entity X relative to other entities in the entity pool. In one embodiment, if a given selection of a mention does not directly map to another mention in a second hierarchy, the financial transparency application may be configured to identify entities in the second hierarchy whose weights exceed a predetermined threshold. The financial transparency application may then prompt the user to select one of the mentions associated with the identified entities as being the mention corresponding to the selection. Alternatively, if a given selection of a mention does not directly map to another mention in the second hierarchy, the financial transparency application may be configured to generate a new Entity Z in the second hierarchy using the mention of Entity X in the first hierarchy.

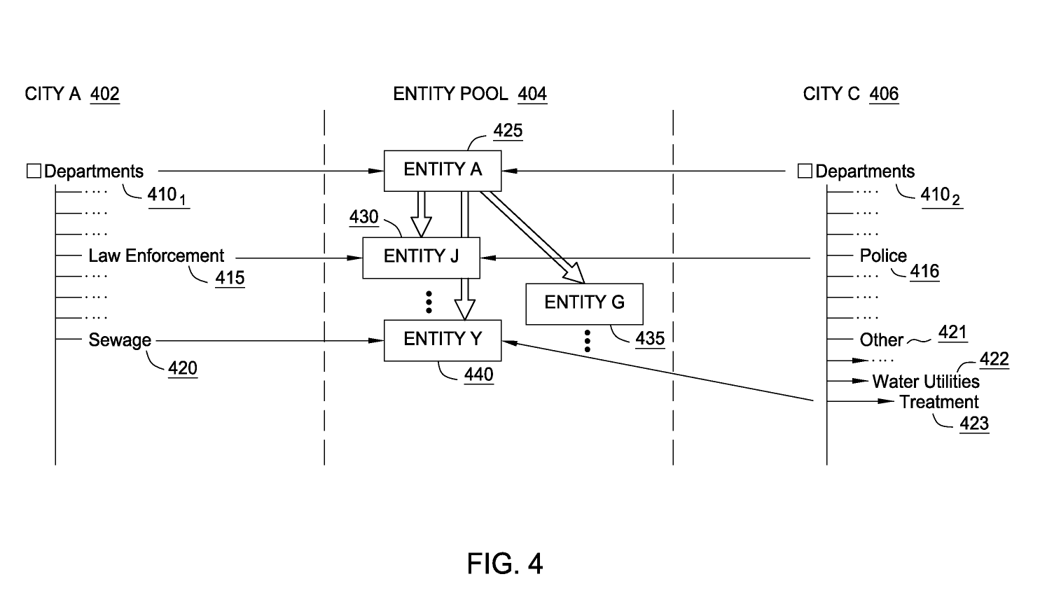

FIG. 4 illustrates an example of mentions in two departmental hierarchies mapped to a common entity in an entity pool 404, according to one embodiment. As shown, City A 402 and City C 406 each provide a departmental hierarchy, with “Departments” 410₁₋₂ being at the top of the hierarchy.

In this example, only the respective departments for each city's police department and sewage treatment department are shown. Specifically, City A 402 lists a “Law Enforcement” department 415 and a “Sewage” department 420, and City C 406 lists a “Police” department 416 and a “Treatment” department 423. The “Treatment” department 423 itself is nested under a “Water Utilities” department 422 which itself is nested under an “Other” categorization 421.

Each department in the departmental hierarchy of City A 402 map to an entity in entity pool 404. “Department” 410₁ maps to Entity A 425. “Law Enforcement” 415 maps to Entity J 430. “Sewage” 420 maps to Entity Y 440. Similarly, each department in the department hierarchy of City C 406 maps to an entity in entity pool 404. “Department” 410₂ maps to Entity A 425. “Police” 416 maps to Entity J 430. “Treatment” 423 maps to Entity Y 440. Illustratively, Entity A serves as a parent entity to Entity J 430, Entity G 435, and Entity Y 440.

Other departments in both City A 402 and City C 406 may map to appropriate entities in Entity Pool 404 (e.g., such as Entity G 435). Additionally, although not shown in FIG. 4, City A 402 and City C 406 themselves may be mapped to different entities.

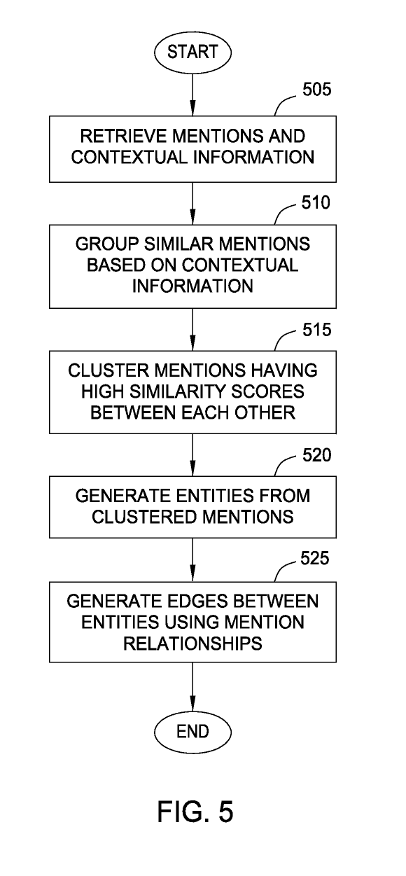

FIG. 5 illustrates a method 500 for generating an entity pool, according to one embodiment. In this example, financial transparency application generates the entity pool using an online encyclopedia as a source. Of course, any other source that provides dense and structured data that focuses on identified terminology may also be used.

The parsing component may be configured to scan a set of “starter” pages of the online encyclopedia. For example, the “starter” pages may relate to general descriptions of finances and budgets, such as a chart of accounts. At step 505, the parsing component iterates through each of the starter pages to obtain mentions and contextual information related to the mentions. The mentions may be nouns or noun phrases. Contextual information may include the location of the mention relative to other mentions within the page, what page (or pages) that the mention is located, the frequency of the mention in within the page (or pages), and so on. Because entities are groups of mentions, each mention serves as a “starter” seed of an entity. Further, each of the given pages may contain links to other subpages. The parsing component may also iterate through each linked subpage and continue to go deeper into subpages to retrieve mentions and contextual information. The depth at which the parsing component traverses through subpages may be configured. For example, the parsing component may be configured to traverse through no deeper than two subpages.

At step 510, the relation building component groups similar mentions based on the contextual information. The relation building component determines a similarity score between each mention. As stated, the similarity score may be determined using known natural language processing techniques, in addition to contextual information of mentions. For example, a mention of “Law Enforcement” may have a higher similarity score relative to “Police” than to “Parks and Recreation.”

At step 515, the relation building component clusters mentions having high similarity scores between other mentions using a clustering algorithm. In one embodiment, a greedy agglomerative clustering algorithm may be used to cluster similar mentions. This approach may produce a quality score for potential clusters that may be maximized to select a preferred clustering of mentions, which in turn results in a preferred entity. Further, the greedy agglomerative hierarchical clustering algorithm allows clusters to be scaled up or down without needing to reprocess each entity. Of course, other types of clustering algorithms may be used to varying degrees of accuracy, run-time, and supervision.

At step 520, the relation building component generates entities from the clustered mentions. Doing so results in a pool of entities. At step 525, the relation building component generates edges between the entities based on the mention relationships.

In one embodiment, a crowdsourcing service (e.g., Amazon Mechanical Turk) may further determine appropriate mappings of mentions to entities. More specifically, the financial transparency application may send current mappings of mentions to entities of the entity pool to a crowdsourcing service. The crowdsourcing service may determine whether a certain mention is accurately mapped to a given entity. If not, the crowdsourcing service may identify a more suitable mapping for an entity. Doing so provides more reliable mappings between mentions and an entity in the entity pool. For example, consider an entity pool that has several mentions associated with an entity that generally relates to law enforcement. Assume that one of the mentions associated with the entity is “Crime Prevention Education.” The crowdsourcing service may determine a more appropriate entity to associate the mention (e.g., an entity related to public welfare services).

In one embodiment, the entity pool may be further refined by parsing additional sources. For example, once an entity pool is generated using an online encyclopedia, the parsing component may iterate through charts of accounts of different cities for mentions and contextual information. The relation building component may use the information collected that is specific to each city to add or separate difference entities in the entity pool.

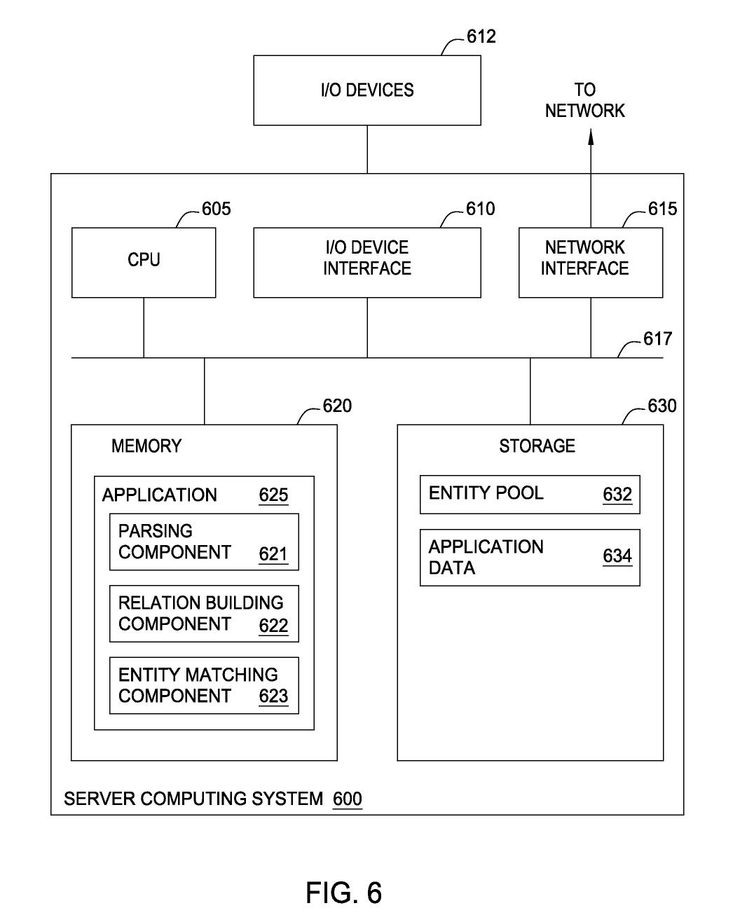

FIG. 6 illustrates an example server computing system 600 configured with an application configured to generate an entity pool, according to one embodiment. As shown, the computing system 600 includes, without limitation, a central processing unit (CPU) 605, a network interface 615, a memory 620, and storage 630, each connected to a bus 617. The computing system 600 may also include an I/O device interface 610 connecting I/O devices 612 (e.g., keyboard, display and mouse devices) to the computing system 600. Further, in context of this disclosure, the computing elements shown in computing system 600 may correspond to a physical computing system (e.g., a system in a data center) or may be a virtual computing instance executing within a computing cloud.

The CPU 605 retrieves and executes programming instructions stored in the memory 620 as well as stores and retrieves application data residing in the storage 630. The interconnect 617 is used to transmit programming instructions and application data between the CPU 605, I/O devices interface 610, storage 630, network interface 615, and memory 620. Note, CPU 605 is included to be representative of a single CPU, multiple CPUs, a single CPU having multiple processing cores, and the like. And the memory 620 is generally included to be representative of a random access memory. The storage 630 may be a disk drive storage device. Although shown as a single unit, the storage 630 may be a combination of fixed and/or removable storage devices, such as fixed disc drives, removable memory cards, or optical storage, network attached storage (NAS), or a storage area-network (SAN).

Illustratively, the memory 620 includes an application 625. The application 625 itself includes a parsing component 621, a relation building component 622, and an entity matching component 623. And the storage 630 includes an entity pool 632 and application data 634. The application 625 generally provides one or more software applications and/or computing resources accessed over a network 620 by users. More specifically, the application 625 processes budgetary data (e.g., application data 634) belonging to local governments and presents the data to a user through graphs and other analytics. The application 625 generates the entity pool 632 using existing entity sources, such as charts of accounts and other publicly available budget sources. The parsing component 621 retrieves documents from online sources and parses the documents for mentions and contextual attributes of the mentions. The relation building component 621 clusters the mentions into entities and defines relationship sets for entity. The entity matching component 622 associates relationship sets between entities. The application 625 uses the entity pool to determine mappings and classifications within a city's financial structure (e.g., budgets, funds, ledgers, and account information, etc.) to retrieve relevant application data 634.

As described, embodiments presented herein provide techniques for generating an entity pool using a variety of public sources. Advantageously, the entity pool clearly defines relationships between entities such that users may make meaningful comparisons across different data sets, despite the data sets not sharing a common organizational or hierarchical structure. Further, because the entity pool may be further refined upon providing additional hierarchies, the techniques described herein are fully scalable.

In the preceding, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet. In context of the present disclosure, the financial transparency application may be hosted on a cloud server. For example, the financial transparency application may be provided to subscribing users as a Software-as-a-Service. Further, the entity pool may be generated on cloud servers. More specifically, the financial transparency application may retrieve online sources to generate the entity pool, and the relation building component may define relationships between entities based on contextual information parsed from the online sources. Advantageously, as entity pool increases in size (e.g., as more entities are added to the entity pool), capacity to accommodate the increase may be easily provisioned to the cloud servers.

While the foregoing is directed to embodiments of the present invention, other and further embodiments of the invention may be devised without departing from the basic scope thereof, and the scope thereof is determined by the claims that follow.

1. A computer-implemented method for generating an entity pool that maps elements from multiple hierarchies to a plurality of nodes, the method comprising:
identifying, by operating of one or more computer processors, a first plurality of mentions and metadata, wherein each mention comprises a text string and wherein the metadata comprises hierarchical information about a corresponding mention;
grouping mentions based on a first measure of similarity;
generating, for each group of mentions, a node in an entity pool; and
identifying relationships between one or more pairs of nodes in the entity pool based on the mentions stored by each node of a given pair of the nodes.

2. The method of claim 1, further comprising:
identifying a second plurality of mentions and metadata;
assigning one or more mentions of the second plurality to a first node in the entity pool; and
updating a relationship between the first node and a second node based on the mentions assigned to the first node.

3. The method of claim 1, wherein the first plurality of mentions and metadata is retrieved from a public source.

4. The method of claim 1, wherein the first plurality of mentions and metadata is retrieved from at least one chart of accounts associated with a governmental entity.

5. The method of claim 1, wherein the hierarchical information is associated with a chart of accounts and wherein the mentions correspond to items in the charts of accounts.

6. The method of claim 1, further comprising, assigning one or more mentions stored by a first node in the entity pool to a second node in the entity pool based on feedback received from a crowdsourcing service.

7. The method of claim 1, wherein the first measure of similarity is based on a first mention and a second mention having a common semantic meaning identified via an ontology.

8. The method of claim 1, wherein the first measure of similarity is based on a string comparison between the text string of a first mention and the text string of a second mention.

9. A non-transitory computer-readable storage medium storing instructions, which, when executed on a processor, performs an operation for generating an entity pool that maps elements from multiple hierarchies to a plurality of nodes, the operation comprising:
identifying a first plurality of mentions and metadata, wherein each mention comprises a text string and wherein the metadata comprises hierarchical information about a corresponding mention;
grouping mentions based on a first measure of similarity;
generating, for each group of mentions, a node in an entity pool; and
identifying relationships between one or more pairs of nodes in the entity pool based on the mentions stored by each node of a given pair of the nodes.

10. The computer-readable storage medium of claim 9, wherein the operation further comprises:
identifying a second plurality of mentions and metadata;
assigning one or more mentions of the second plurality to a first node in the entity pool; and
updating a relationship between the first node and a second node based on the mentions assigned to the first node

11. The computer-readable storage medium of claim 9, wherein the first plurality of mentions and metadata is retrieved from a public source.

12. The computer-readable storage medium of claim 9, wherein the first plurality of mentions and metadata is retrieved from at least one chart of accounts associated with a governmental entity.

13. The computer-readable storage medium of claim 9, wherein the hierarchical information is associated with a chart of accounts and wherein the mentions correspond to items in the charts of accounts.

14. The computer-readable storage medium of claim 9, wherein the operation further comprises, assigning one or more mentions stored by a first node in the entity pool to a second node in the entity pool based on feedback received from a crowdsourcing service.

15. The computer-readable storage medium of claim 9, wherein the first measure of similarity is based on a first mention and a second mention having a common semantic meaning identified via an ontology.

16. The computer-readable storage medium of claim 9, wherein the first measure of similarity is based on a literal string comparison between the text string of a first mention and the text string of a second mention.

17. A system, comprising:
a processor and
a memory hosting an application, which, when executed on the processor, performs an operation for generating an entity pool that maps elements from multiple hierarchies to a plurality of nodes, the operation comprising:
identifying a first plurality of mentions and metadata, wherein each mention comprises a text string and wherein the metadata comprises hierarchical information about a corresponding mention
grouping mentions based on a first measure of similarity,
generating, for each group of mentions, a node in an entity pool, and
identifying relationships between one or more pairs of nodes in the entity pool based on the mentions stored by each node of a given pair of the nodes.

18. The system of claim 17, wherein the operation further comprises:
identifying a second plurality of mentions and metadata;
assigning one or more mentions of the second plurality to a first node in the entity pool; and
updating a relationship between the first node and a second node based on the mentions assigned to the first node.

19. The system of claim 17, wherein the first plurality of mentions and metadata is retrieved from a public source.

20. The system of claim 17, wherein the first plurality of mentions and metadata is retrieved from at least one chart of accounts with a governmental entity.

21. The system of claim 17, wherein the hierarchical information is associated with a chart of accounts and wherein the mentions correspond to items in the charts of accounts.

22. The system of claim 17, wherein the operation further comprises, assigning one or more mentions stored by a first node in the entity pool to a second node in the entity pool based on feedback received from a crowdsourcing service.

23. The system of claim 17, wherein the first measure of similarity is based on a first mention and a second mention having a common semantic meaning identified via an ontology.

24. The system of claim 17, wherein the first measure of similarity is based on a literal string comparison between the text string of a first mention and the text string of a second mention.

25. The method of claim 1, wherein the method further comprises assigning a second measure of similarity to the identified relationship between at least a first pair of the nodes.

26. The computer-readable storage medium of claim 9, wherein the operation further comprises, assigning a second measure of similarity to the identified relationship between at least a first pair of the nodes.

27. The system of claim 17, wherein the operation further comprises assigning a second measure of similarity to the identified relationship between at least a first pair of the nodes.
